(19) United States
(12) Patent Application Publication
(10) Pub. No.: US 2007/0074523 A1
(43) Pub. Date: Apr. 5, 2007

(54) Refrigerating apparatus

(76) Inventors: Masaaki Takegami, Osaka (JP); Satoru Sakae, Osaka (JP); Kenji Tanimoto, Osaka (JP); Kazuyoshi Nomura, Osaka (JP); Azuma Kondo, Osaka (JP); Yoshinari Oda, Osaka (JP)

Correspondence Address: BIRCH STEWART KOLASCH & BIRCH, PO BOX 747, FALLS CHURCH, VA, 22040-0747, US

(21) Appl. No.: 10/577,011

(22) PCT Filed: Sep. 2, 2005
(86) PCT No.: PCT/JP05/16109

§ 371 Date: Apr. 25, 2006

(30) Foreign Application Priority Data
Sep. 3, 2004 (JP) 2004-257086

(51) Int. Cl. F25D 21/06; G05D 23/32; F25D 21/00

(52) U.S. Cl. 62/151; 62/157; 62/272

(57) ABSTRACT

A refrigerator circuit (110) and a freezing circuit (30) are connected to an outdoor circuit (40) in parallel in a refrigerant circuit (20), and a freezer circuit (130) and a booster circuit (140) are connected in series in the freezing circuit (30). The booster circuit (140) includes a booster compressor (141) and three-way switching mechanisms (142, 160). During cooling operation of a freezing heat exchanger (131), first operation is performed in the three-way switching mechanisms (142, 160) so that the refrigerant evaporated in the freezing heat exchanger (131) is compressed in the booster compressor (141) and is sucked into a variable capacity compressor (41). During defrosting of the freezing heat exchanger (131), second operation is performed in the three-way switching mechanisms (142, 160) so that the refrigerant evaporated in the refrigeration heat exchanger (111) is compressed in the booster compressor (141), is supplied to the freezing heat exchanger (131), and then, is sent back to the refrigeration heat exchanger (111).

### TECHNICAL FIELD

The present invention relates to a refrigerating apparatus including a plurality of heat exchangers for cooling the inside of a refrigerator and the like.

### BACKGROUND ART

Conventionally, refrigerating apparatuses including a refrigerant circuit for performing a refrigeration cycle have been known and have been used widely as coolers such as refrigerators and the like for storing food and the like. For example, Patent Document 1 discloses a refrigerating apparatus including a plurality of heat exchangers for cooling the inside of a refrigerator and the like. In this refrigerating apparatus, a refrigeration heat exchanger for cooling the inside of a refrigerator and a freezing heat exchanger for cooling the inside of a freezer are connected to one outdoor unit in parallel. Also, in this refrigerating apparatus, a sub compressor is provided between the freezing heat exchanger and the outdoor unit, in addition to a main compressor of the outdoor unit. In this refrigerating apparatus, a single refrigerant circuit performs a single-stage refrigerating cycle using the refrigeration heat exchanger as an evaporator and a two-stage compression refrigerating cycle using the freezing heat exchanger as an evaporator and the sub compressor as a low-pressure compressor.

In the above refrigerating apparatus, the evaporation temperature of the refrigerant in the freezing heat exchanger is set comparatively low. This causes moisture in the air to adhere to the freezing heat exchanger and to be frozen, with a result that the adhering frost inhibits cooling of the inside air. Under the circumstances, it is required to melt the frost adhering to the freezing heat exchanger, namely, to defrost the freezing heat exchanger.

In general, a freezing heat exchanger is defrosted with the use of an electric heater as disclosed in Patent Document 2. In detail, the general refrigerating apparatus performs defrosting operation in such a manner that air heated by the electric heater is supplied to the freezing heat exchanger to warm and melt the frost adhering to the freezing heat exchanger with the air.

Alternatively, the freezing heat exchanger is defrosted by a generally called hot gas bypass as disclosed in Patent Document 3. Specifically, it proposes that the refrigerant is circulated only between the compressor and the freezing heat exchanger while gas refrigerant at comparatively high temperature discharged from the compressor is introduced into the freezing heat exchanger, thereby melting the frost.

Patent Document 1: Japanese Patent Application Laid Open Publication No. 2002-228297A

Patent Document 2: Japanese Patent Application Laid Open Publication No. 09-324978A

Patent Document 3: Japanese Patent Application Laid Open Publication No. 2001-183037A

### SUMMARY OF THE INVENTION

Problems that the Invention is to Solve

As described above, it is general that the electric heater is used for defrosting the freezing heat exchanger as in the aforementioned refrigerating apparatus. In this case, however, the air heated by the electric heater is supplied to the freezing heat exchanger for melting the frost to cause the heated air to flow into the freezer, inviting an increase in inside temperature of the freezer. In addition, the frost adhering to the freezing heat exchanger must be wormed from the outside by the air. This means that it takes long time (over 40 minutes, for example) to defrost the freezing heat exchanger.

The above problems may be solved to some extent by defrosting the freezing heat exchanger by the hot gas bypass. In the defrosting by the hot gas bypass, the refrigerant at high temperature is introduced into the heat transfer tube of the freezing heat exchanger to warm the frost adhering to the freezing heat exchanger from the inside. For this reason, an increase in inside temperature in defrosting of the freezing heat exchanger is suppressed compared with the case of defrosting with the use of the electric heater.

However, during the defrosting by the hot gas bypass, the refrigerant circulates only between the compressor and the freezing heat exchanger, and accordingly, heat that can be utilized for defrosting the frost is only heat provided to the refrigerant in the compressor. Thus, the problem that it takes long time to defrost the freezing heat exchanger stands still.

Moreover, the refrigerant supplied to the freezing heat exchanger is merely sucked into the compressor again, which means that the refrigerant is utilized only for defrosting the freezing heat exchanger. In other words, the compressor is operated only for defrosting the freezing heat exchanger during the defrosting of the freezing heat exchanger.

This increases power consumption in association with the defrosting of the freezing heat exchanger as in the case using the electric heater, thereby inviting an increase in running cost of the refrigerating apparatus.

The present invention has been made in view of the foregoing and has its object of reducing, in a refrigerating apparatus including a plurality of heat exchanges for cooling the inside of a refrigerator and the like, time required for defrosting a heat exchanger for cooling the inside and of reducing running cost by reducing power consumption of the refrigerating apparatus.

Means of Solving the Problems

In the present invention, in a refrigerating apparatus including a refrigerant circuit including a plurality of heat exchangers, three-way switching mechanisms are provided so that in defrosting of a freezing heat exchanger, refrigerant from a refrigeration heat exchanger is compressed in a sub compressor, and then, is allowed to circulate in the refrigeration heat exchanger through the freezing heat exchanger.

More specifically, the first invention directs to a refrigerating apparatus including a refrigerant circuit (20) in which a first cooling circuit (110) having a first heat exchanger (111) for cooling inside and a second cooling circuit (30) having a second heat exchanger (131) for cooling inside and a sub compressor (141) are connected in parallel to a heat source side circuit (40) having a main compressor (41). Wherein, the refrigerant circuit (20) includes three-way switching mechanisms (142, 160) for switching between first operation for sending, after refrigerant from the second heat exchanger (131) is compressed in the sub compressor (141), the refrigerant to a suction side of the main compressor (41) and second operation for circulating, after refrigerant from the first heat exchanger (111) is compressed in the sub compressor (141), the refrigerant to the first heat exchanger (111) through the second heat exchanger (131), and the refrigerant circuit (20) performs the second operation during defrosting operation for defrosting the second heat exchanger (131).

In the first invention, the refrigerant circuit (20) is provided in the refrigerating apparatus. In the refrigerant circuit (20), the first cooling circuit (110) and the second cooling circuit (30) are connected to the heat source side circuit (40) in parallel. The refrigerant circuit (20) includes the three-way switching mechanisms (142, 160). In the refrigerant circuit (20), operation of the three-way switching mechanisms (142, 160) attains exchange between the first operation and the second operation. In both the first operation and the second operation, the refrigerant supplied from the heat source side circuit (40) to the first cooling circuit (10) is evaporated in the first heat exchanger (111), and then, is sucked into the main compressor (41). In the first operation, the refrigerant supplied from the heat source side circuit (40) to the second cooling circuit (30) is evaporated in the second heat exchanger (131), is sucked into the sub compressor (141) to be compressed in the sub compressor (141), and then, is sucked into the main compressor (41).

In this invention, the refrigerating apparatus (10) performs the defrosting operation for defrosting the second heat exchanger (131). During the defrosting operation, the second operation is performed in the refrigerant circuit (20). In the second operation, the sub compressor (141) sucks and compresses the refrigerant evaporated in the first heat exchanger (111) and supplies the thus compressed refrigerant to the second heat exchanger (131). In the second heat exchanger (131), adhering frost is heated and melt by the refrigerant supplied from the sub compressor (141). Thus, the heat that the refrigerant absorbs in the first heat exchanger (111) and the heat provided to the refrigerant in the sub compressor (141) are utilized for defrosting the second heat exchanger (131). The refrigerant condensed by heat radiation in the second heat exchanger (131) is circulated to the first heat exchanger (111) so as to be utilized again for cooling the inside. In other words, the refrigerant for defrosting supplied from the sub compressor (141) to the second heat exchanger (131) is returned to the first heat exchanger (111) so as to be utilized also for cooling the inside.

Referring to the second invention, in the refrigerating apparatus of the first invention, the three-way switching mechanisms (142, 160) are a first three-way switching mechanism (142) for allowing the second heat exchanger (131) to communicate with a suction side of the sub compressor (141) in the first operation and allowing the second heat exchanger (131) to communicate with a discharge side of the sub compressor (141) in the second operation and a second three-way switching mechanism (160) for allowing the suction side of the main compressor (41) to communicate with the discharge side of the sub compressor (141) in the first operation and allowing the suction side of the main compressor (41) to communicate with the suction side of the sub compressor (141) in the second operation.

In the second invention, the first and second three-way switching mechanisms (142, 160) are provided in the refrigerant circuit (20). In the first operation, the first three-way switching mechanism (142) allows the second heat exchanger (131) to communicate with the suction side of the sub compressor (141) so that the refrigerant evaporated in the second heat exchanger (131) is sucked into the sub compressor (141) to be compressed. At the same time, the second three-way switching mechanism (160) allows the discharge side of the sub compressor (141) to communicate with the suction side of the main compressor (41) so that the refrigerant compressed in the sub compressor (141) is sucked into the main compressor (41).

On the other hand, in the second operation, the second three-way switching mechanism (160) allows the suction side of the sub compressor (141) to communicate with the suction side of the main compressor, that is, the outlet side of the first heat exchanger (111) so that the refrigerant evaporated in the first heat exchanger (111) is sucked into the sub compressor (141) to be compressed. At the same time, the first three-way switching mechanism (142) allows the discharge side of the sub compressor (141) to communicate with the second heat exchanger (131) so that the refrigerant compressed in the sub compressor (141) is supplied to the second heat exchanger (131). In the second heat exchanger (131), adhering frost is heated and melted by the refrigerant supplied from the sub compressor (141). Thus, the heat that the refrigerant absorbs in the first heat exchanger (111) and the heat provided to the refrigerant in the sub compressor (141) are utilized for defrosting the second heat exchanger (131). The refrigerant condensed by heat radiation in the second heat exchanger (131) is circulated to the first heat exchanger (111) to be utilized again for cooling the inside. In other words, the refrigerant for defrosting supplied from the sub compressor (141) to the second heat exchanger (131) is returned to the first heat exchanger (111) so as to be utilized also for cooling the inside.

Referring to the third invention, in the refrigerating apparatus of the second invention, the three-way switching mechanisms (142) are three-way valves.

In the third invention, the three way valve (142) is used as either of the three-way switching mechanisms for exchanging, as in the second invention, the refrigerant flow in the refrigerant circuit (20). The change in opening/closing of the three way valve (142) exchanges the refrigerant circuit (20) between the first operation and the second operation.

Referring to the fourth invention, in the refrigerating apparatus of the second invention, either (160) of the three-way switching mechanisms is composed of a main pipe (163), two branch pipes (161, 162) branching in two ways from the main pipe (163), and a pair of on-off valves (SV-8, SV-9) which are provided in the branch pipes (161, 162) and one of which is closed when the other is opened.

In the fourth invention, the main pipe (163), the branch pipes (161, 162), and the on-off valves (SV-8, SV-9) are used as either of the three way switching mechanisms for exchanging, as in the second invention, the refrigerant flow in the refrigerant circuit (20). Three-way switching mechanism (160) switches between the state that the on-off valve (SV-8) of the first branch pipe (161) is closed while the on-off valve (SV-9) of the second branch pipe (162) is opened and the state that the on-off valve (SV-8) of the first branch pipe (161) is opened while the on-off valve (SV-9) of the second branch pipe (162) is closed so that the refrigerant circuit (20) is exchanged between the first operation and the second operation.

Referring to the fifth invention, in the refrigerating apparatus of any one of the first to fourth inventions, the second cooling circuit (30) includes: a thermostatic expansion valve (132) which detects temperature of the refrigerant flowing out from the second heat exchanger (131) for adjusting opening of its own; and a first bypass passage (133) in which refrigerant bypassing the thermostatic expansion valve (132) flows in only the second operation.

In the fifth invention, the thermostatic expansion valve (132) is provided in the second cooling circuit (30). In the first operation, the refrigerant supplied from the heat source side circuit (40) to the second cooling circuit (30) is pressure-reduced when passing through the thermostatic expansion valve (132), and then, is introduced into the second heat exchanger (131). At that time, the thermostatic expansion valve (132) detects the temperature of the refrigerant flowing into the second heat exchanger (131) and adjusts the opening of its own on the basis of the detection temperature. On the other hand, in the second operation in which the defrosting operation is performed, the refrigerant supplied from the sub compressor (141) to the second heat exchanger (131) bypasses the thermostatic expansion valve (132) and passes through the first bypass passage (133). In other words, the refrigerant utilized for defrosting the second heat exchanger (131) is sent to the first heat exchanger (111) without passing through the thermostatic expansion valve (132).

Referring to the sixth invention, in the refrigerating apparatus of any one of first to fourth inventions, the second cooling circuit (30) includes an expansion valve (138) variable in opening, and the refrigerating apparatus further includes control means (201) for keeping the expansion valve (138) being opened fully in the second operation.

In the sixth invention, the expansion valve (138) variable in opening is provided in the second cooling circuit (30). In the first operation, the refrigerant supplied from the heat source side circuit (40) to the second cooling circuit (30) is pressure-reduced when passing through the expansion valve (138), and then, is introduced into the second heat exchanger (131). On the other hand, in the second operation in which the defrosting operation is performed, the control means (201) keeps the expansion valve (138) of the second cooling circuit (30) being opened fully. Accordingly, the refrigerant supplied from the sub compressor (141) to the second heat exchanger (131) and utilized for defrosting the second heat exchanger (131) in the second operation passes through the expansion valve (138), which is opened fully, and then, is sent to the first heat exchanger (111).

Referring to the seventh invention, in the refrigerating apparatus of any one of the first to sixth inventions, the refrigerant circuit (20) includes a second bypass passage (156) in which refrigerant bypassing the sub compressor (141) flows during stop of the sub compressor (141), and the refrigerating apparatus further includes control means (202) for stopping, in transition from the second operation to the first operation in termination of the defrosting operation, the sub compressor (141) for a predetermined time period and allowing the sub compressor (141) to start operating thereafter.

In the seventh invention, the second bypass passage (156) is provided in the refrigerant circuit (20). After the defrosting operation terminates, the refrigerant circuit (20) is exchanged from the second operation to the first operation. In this exchange, the control means (202) performs a given operation. Specifically, the control means (202) once stops the sub compressor (141), which has been operated during the second operation, and then, starts the sub compressor (141) after a predetermined time period elapses.

Wherein, during the second operation, the refrigerant is supplied form the sub compressor (141) to the second heat exchanger (131). Only part of the refrigerant condensed in the second heat exchanger (131) is sent to the first heat exchanger (111) and the other part thereof remains in the second heat exchanger (131). For this reason, mere exchange to the first operation by operating the three-way switching mechanisms (142, 160) causes the sub compressor (141) to suck the liquid refrigerant remaining in the second heat exchanger (131), inviting damage to the sub compressor (141).

In contrast, in the seventh invention, the control means (202) keeps the sub compressor (141) being stopped temporally. Therefore, the liquid refrigerant remaining in the second heat exchanger (131) in the second operation flows into the second bypass passage (156) so as to bypass the sub compressor (141), which is being stopped, and then, is sent to the heat source side circuit (40). Hence, if the sub compressor (141) would start operating only after the liquid refrigerant is discharged fully from the second heat exchanger (131), the liquid refrigerant is not sucked into the sub compressor (141), causing no damage thereto.

Referring to the eighth invention, the refrigerating apparatus of any one of the first to seventh inventions further includes defrosting start judging means for allowing the defrosting operation to start by switching the refrigerant circuit (20) from the first operation to the second operation, the defrosting start judging means allowing the defrosting operation to start on the basis of elapsed time after the first operation starts, an amount of frost of the second heat exchanger (131), or inside temperature of equipment in which the second heat exchanger (131) is provided.

In the eighth invention, the defrosting start judging means judges the start timing of the defrosting operation, and the refrigerant circuit (20) is exchanged from the first operation to the second operation. Specifically, the defrosting start judging means judges that the cooling power of the second heat exchanger (131) is lowered by frost, for example, when a predetermined time period elapses after the first operation starts, when an increase in frost amount of the second heat exchanger (131) is detected indirectly, or when the inside temperature around the second heat exchanger (131) rises. Then, the defrosting start judging means allows the refrigerant circuit (20) to perform the second operation.

Referring to the ninth invention, the refrigerating apparatus of any one of the first to seventh inventions further includes defrosting end judging means for terminating the defrosting operation by switching the refrigerant circuit (20) from the second operation to the first operation, the defrosting start judging means terminating the defrosting operation on the basis of elapsed time after the second operation starts, discharge pressure of the sub compressor (141), temperature of the refrigerant flowing in the second heat exchanger (131), or inside temperature of equipment in which the second heat exchanger (131) is provided.

In the ninth invention, the defrosting end judging means judges the end timing of the defrosting operation, and the refrigerant circuit (20) is exchanged from the second operation to the first operation. Specifically, the defrosting end judging means judges that defrosting of the second heat exchanger (131) is completed, for example, when a predetermined time period elapses after the second operation starts, when the pressure of the refrigerant discharged from the sub compressor (141) increases, when the temperature of the refrigerant flowing in the second heat exchanger (131) rises, or the inside temperature around the second heat exchanger (131) rises. Then, the defrosting end judging means allows the refrigerant circuit (20) to perform the first operation so that the cooling of the inside by the second heat exchanger (131) starts again.

Effects of the Invention

In the first invention, the second operation is performed during the defrosting operation for defrosting the second heat exchanger (131), and the refrigerant evaporated in the first heat exchanger (111) is compressed in the sub compressor (141), and then, is supplied to the second heat exchanger (131). Accordingly, both the heat that the refrigerant absorbs in the first heat exchanger (111) and the heat provided to the refrigerant in the sub compressor (141) can be utilized as the heat for melting the frost in the second heat exchanger (131). Hence, according to the present invention, a large amount of heat usable for defrosting the second heat exchanger (131) can be secured, compared with the conventional one, resulting in remarkable reduction in time required for defrosting the second heat exchanger (131).

Further, in this invention, the refrigerant condensed in the second heat exchanger (131) in the defrosting operation is sent back to the first heat exchanger (111). Further, the refrigerant of which enthalpy is lowered by heat radiation in the second heat exchanger (131) is utilized also for cooling the inside by the first heat exchanger (111). Accordingly, the operation of the sub compressor (141) during the defrosting operation also attains cooling power in the first heat exchanger (111). As a result, the power consumption in the main compressor (41) can be reduced by the thus attained cooling power. Hence, according to the present invention, the power consumption of the main compressor (41) and the sub compressor (141) can be reduced to reduce the power consumption of the refrigerating apparatus (10), resulting in reduction in running cost.

According to the second invention, operation of the first and second three-way switching mechanisms (142, 160) exchanges the refrigerant circuit (20) between the first operation and the second operation. Hence, the effects described in relation to the first invention can be obtained.

According to the third invention, with the use of the tree way valve as either of the three-way switching mechanisms (142), the refrigerant flow in the refrigerant circuit (20) can be changed in a predetermined direction, so that the exchange between the first operation and the second operation can be carried out readily.

According to the fourth invention, with the use of the main pipe (163), the two branch pipes (161, 162), and the two on-off valves (SV-7, SV-8) as either of the three-way switching mechanisms (160), the refrigerant flow in the refrigerant circuit (20) can be changed in a predetermined direction, so that the exchange between the first operation and the second operation can be carried out readily.

In the fifth invention, the refrigerant supplied to the second heat exchanger (131) in the defrosting operation bypasses the thermostatic expansion valve (132), and then, is sent to the first heat exchanger (111). This enables the refrigerant in the second heat exchanger (131) to be sent to the first heat exchanger (111) reliably even in the case where the thermostatic expansion valve (132) is closed fully or is closed to a certain opening degree because of, for example, influence of the temperature of the refrigerant flowing in the second heat exchanger (131). Hence, according to this invention, the refrigerant condensed in the second heat exchanger (131) can be sent to the first heat exchanger (111) in the defrosting operation irrespective of the opening degree of the thermostatic expansion valve (132).

In the sixth invention, the control means (201) keeps the expansion valve (138) of the second cooling circuit (30) being opened fully during the defrosting operation. Accordingly, the refrigerant condensed in the second heat exchanger (131) in the defrosting operation can be sent to the first heat exchanger (111) reliably.

In the seventh invention, the control means (202) once stops the sub compressor (141) temporally in termination of the defrosting operation so that the liquid refrigerant is discharged from the second heat exchanger (131) through the second bypass passage (156) during the stop of the sub compressor (141). This surely avoids the situation that the liquid refrigerant remaining in the second heat exchanger (131) in the defrosting operation is sucked into the sub compressor (141). Hence, according to this invention, damage to the sub compressor (141), which is caused due to sucking of the liquid refrigerant, can be prevented, enhancing the reliability of the refrigerating apparatus (10).

In the eighth invention, the defrosting start judging means surely judges the timing at which the defrosting operation is necessary, ensuring start of the defrosting operation. Hence, the efficiency of cooling of the inside is prevented from remarkable lowering in association with frosting in the second heat exchanger (131), and the defrosting operation can be performed at a minimum frequency.

In the ninth invention, the defrosting operation is terminated when the defrosting end judging means surely judges the timing at which defrosting of the second heat exchanger (131) is completed. Hence, rise in inside temperature, which is caused due to excessive defrosting operation, can be obviated, and the time for the defrosting operation can be shortened.

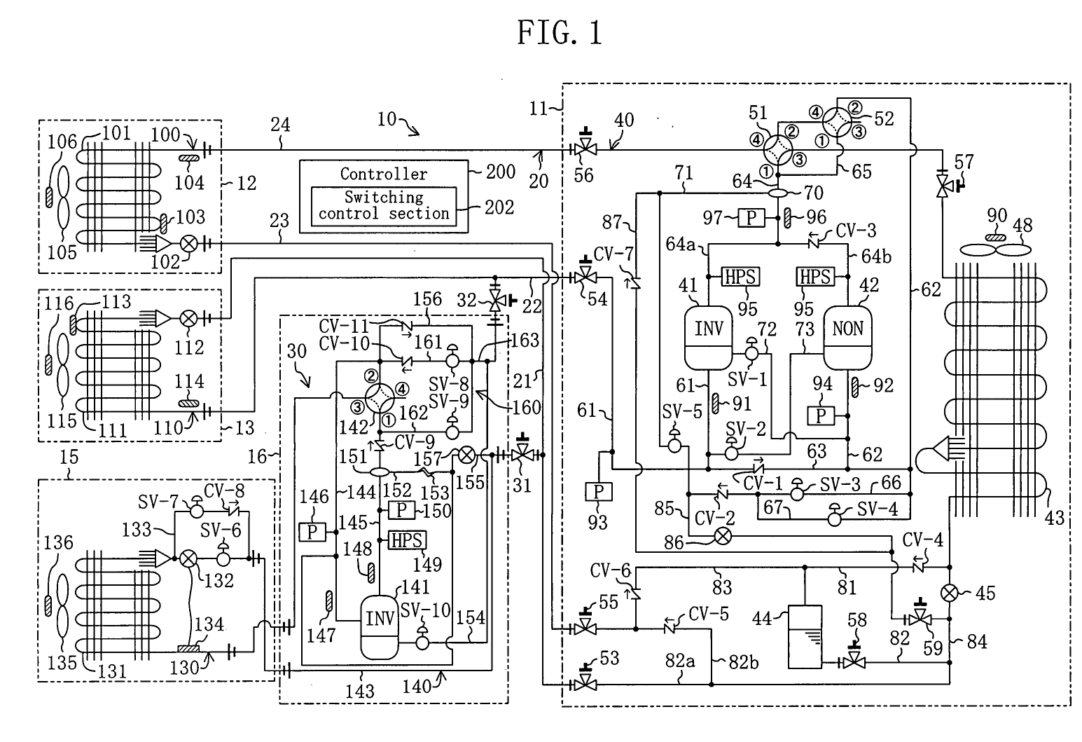

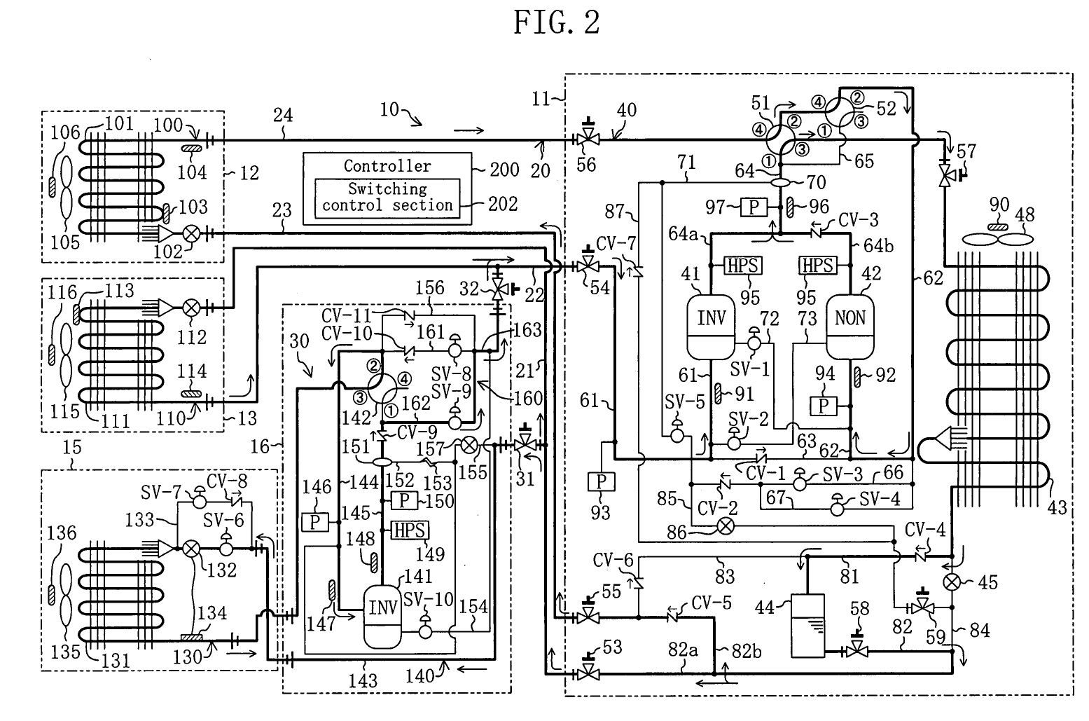

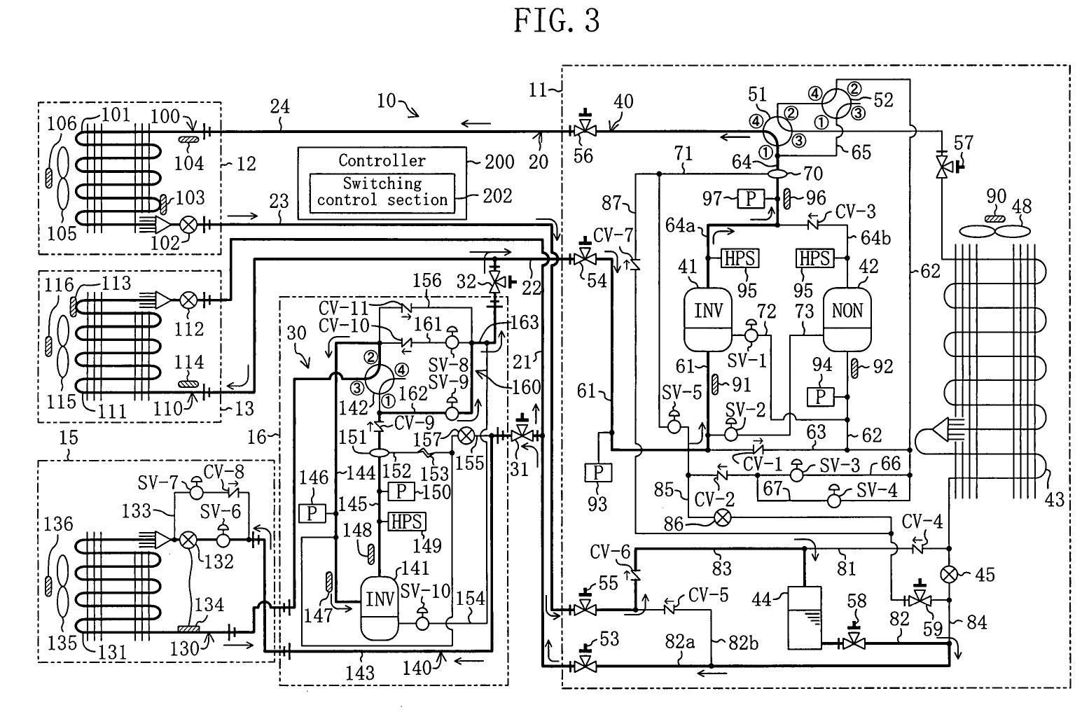

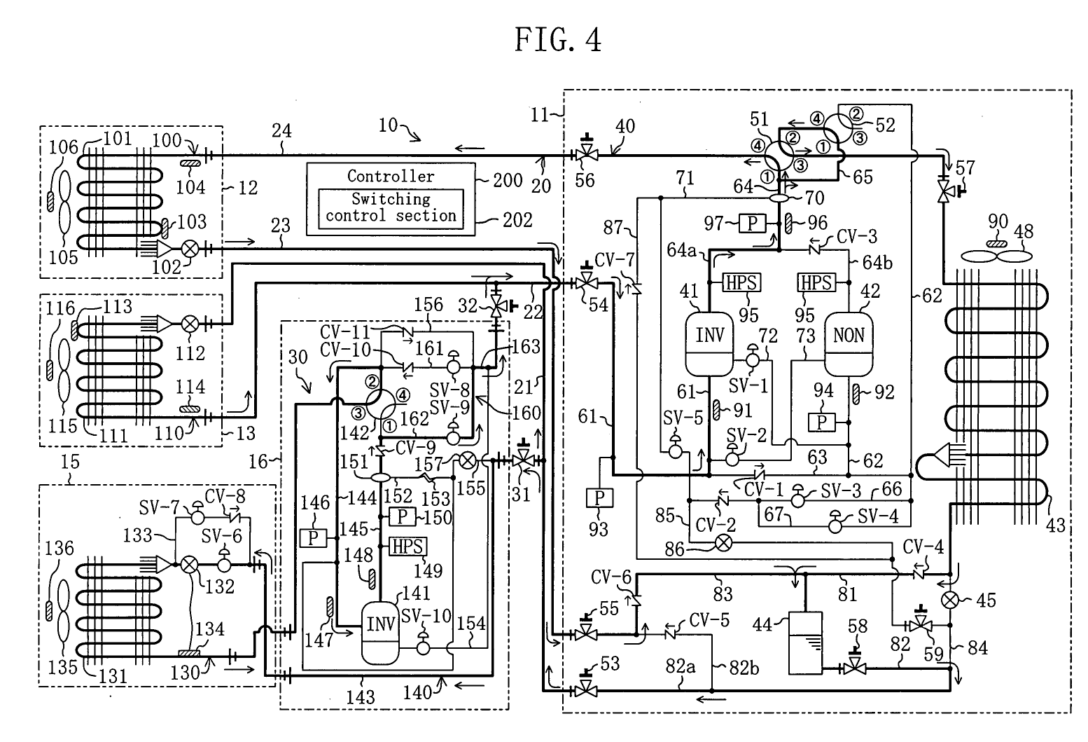

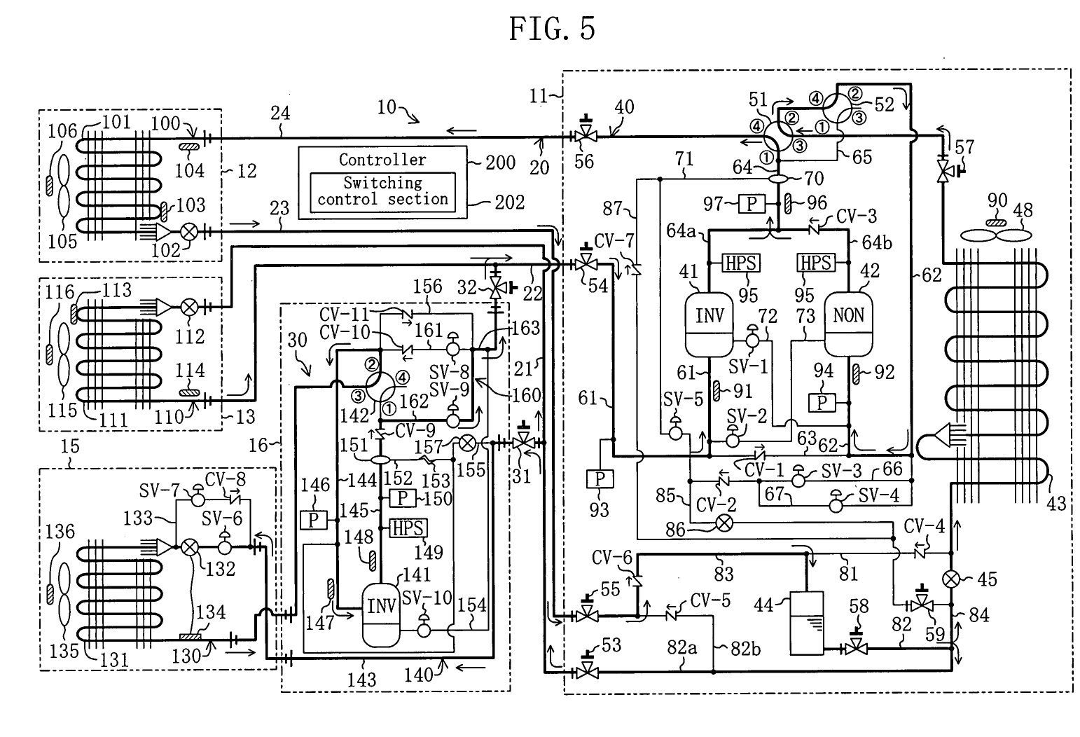

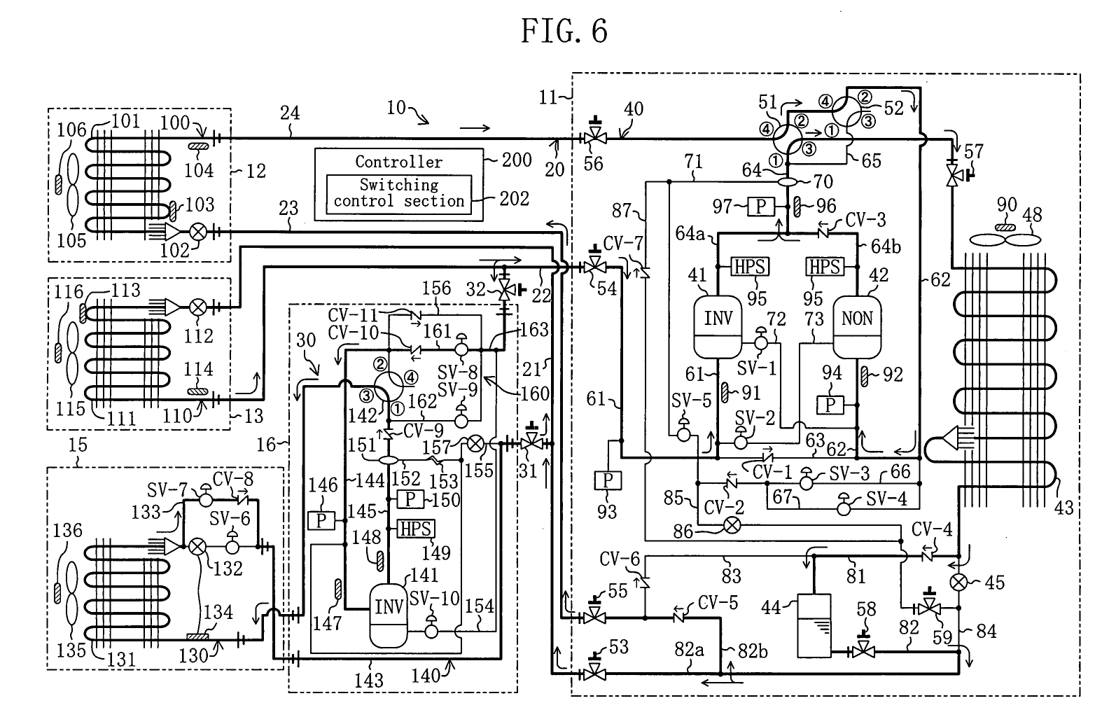

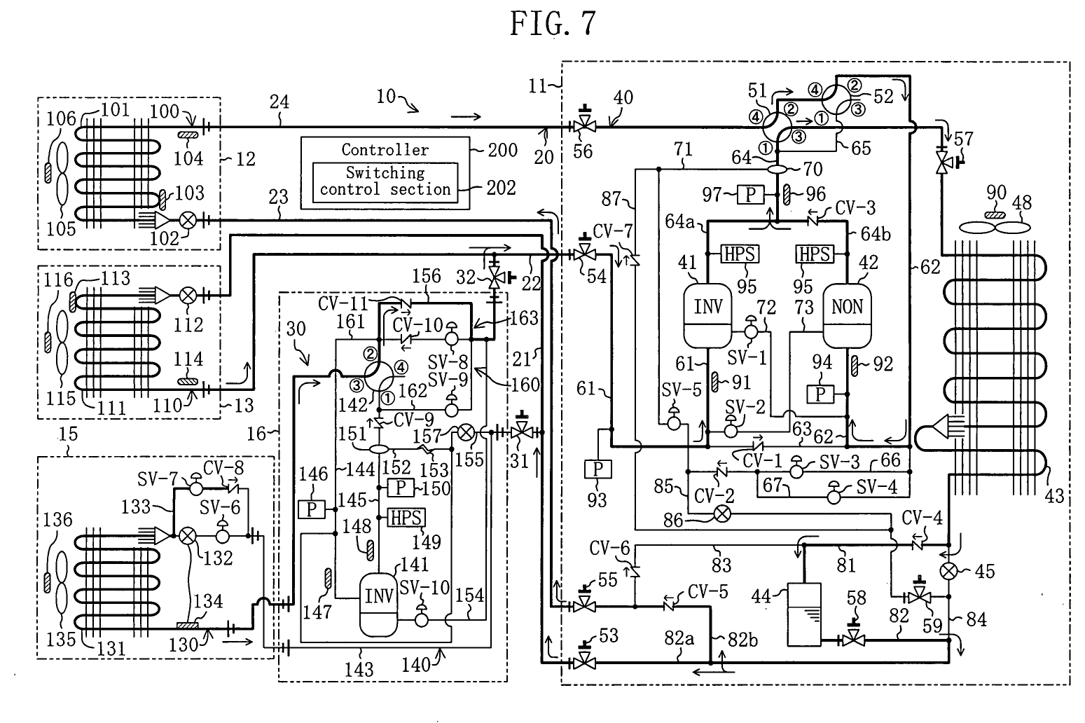

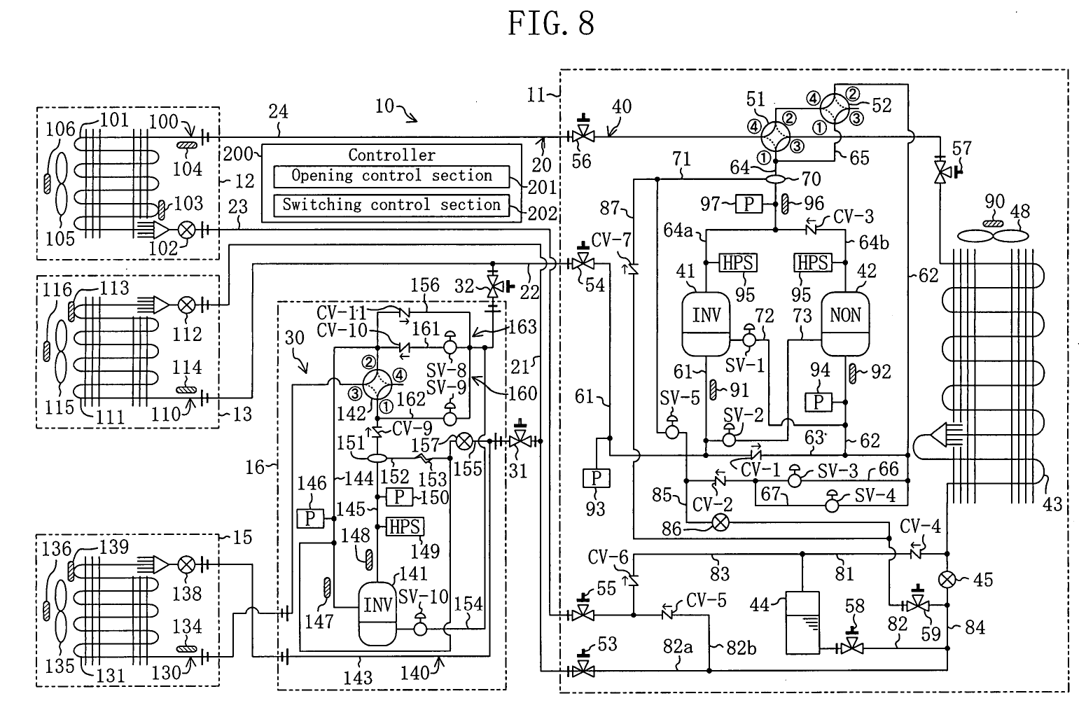

### BRIEF DESCRIPTION OF THE DRAWINGS

[FIG. 1] FIG. 1 is a schematic system diagram of a refrigerating apparatus according to an embodiment.

[FIG. 2] FIG. 2 is a schematic system diagram of the refrigerating apparatus which shows a refrigerant flow during cooling operation.

[FIG. 3] FIG. 3 is a schematic system diagram of the refrigerating apparatus which shows a refrigerant flow during first heating operation.

[FIG. 4] FIG. 4 is a schematic system diagram of the refrigerating apparatus which shows a refrigerant flow during second heating operation.

[FIG. 5] FIG. 5 is a schematic system diagram of the refrigerating apparatus which shows a refrigerant flow during third heating operation.

[FIG. 6] FIG. 6 is a schematic system diagram of the refrigerating apparatus which shows a refrigerant flow during defrosting operation.

[FIG. 7] FIG. 7 is a schematic system diagram of the refrigerating apparatus which shows a refrigerant flow at termination of the defrosting operation.

[FIG. 8] FIG. 8 is a schematic system diagram of a refrigerating apparatus according to a modified example of the embodiment.

### EXPLANATION OF REFERENCE NUMERALS

(20) refrigerant circuit

(30) freezing circuit (second cooling circuit)

(40) outdoor circuit (heat source side circuit)

(41) variable capacity compressor (main compressor)

(43) outdoor heat exchanger (heat source side heat exchanger)

(110) refrigerator circuit (first cooling circuit)

(111) refrigeration heat exchanger (first heat exchanger)

(120) refrigerator circuit (first cooling circuit)

(121) refrigeration heat exchanger (first heat exchanger)

(131) freezing heat exchanger (second heat exchanger)

(132) freezing expansion valve (thermostatic expansion valve)

(133) first bypass pipe (first bypass passage)

(138) electronic expansion valve (expansion valve)

(141) booster compressor (sub compressor)

(142) four-way switching valve (first three-way switching mechanism)

(156) second bypass pipe (second bypass passage)

(160) second three-way switching mechanism

(161) first branch pipe

(162) second branch pipe

(163) main pipe

(201) opening control section (control means)

(202) switching control section (control means)

(SV-8, SV-9) on-off valves

### BEST MODE FOR CARRYING OUT THE INVENTION

Embodiments of the present invention will be described in detail with reference to the drawings. A refrigerating apparatus (10) in the present embodiment is installed in a convenience store or the like and performs air conditioning of the inside of the store and cooling of the inside of showcases.

As shown in FIG. 1, the refrigerator (10) in the present embodiment includes an outdoor unit (11), an air conditioning unit (12), a refrigerator showcase (13) as a refrigerator, a freezer showcase (15) as a freezer, and a booster unit (16). The outdoor unit (11) is installed outdoors while the other units such as the air conditioning unit (12) and the like are installed in the store such as a convenience store or the like.

The outdoor unit (11) includes an outdoor circuit (40), the air conditioning unit (12) includes an air conditioning circuit (100), the refrigerator showcase (13) includes a refrigerator circuit (110), the freezer showcase (15) includes a freezer circuit (130), and the booster unit (15) includes a booster circuit (140). In the refrigerating apparatus (10), the aforementioned circuits (40, 100, . . . ) are connected by means of pipes to form a refrigerant circuit (20).

The freezer circuit (130) and the booster circuit (140) are connected in series to each other to form a freezing circuit (30) as a second cooling circuit. In the freezing circuit (30), a liquid side closing valve (31) and a gas side closing valve (32) are provide at the respective ends of the booster unit (16). On the other hand, the refrigerator circuit (110) forms a first cooling circuit solely. The outdoor circuit (40) forms a heat source side circuit solely.

In the refrigerant circuit (20), the refrigerator circuit (110) and the freezing circuit (30) are connected to the outdoor circuit (40) in parallel. Specifically, the refrigerator circuit (110) and the freezing circuit (30) are connected to the outdoor circuit (40) by means of a first liquid side communication pipe (21) and a first gas side communication pipe (22). The first liquid side communication pipe (21) is connected at one end thereof to the outdoor circuit (40). The other end of the first liquid side communication pipe (21) branches into two, wherein one of the branch ends is connected to the liquid side end of the refrigerator circuit (110) while the other end thereof is connected to the liquid side closing valve (31). The first gas side communication pipe (22) is connected at one end thereof to the outdoor circuit (40). The other end of the first gas side communication pipe (22) branches into two, wherein one of the branch ends is connected to the gas side end of the refrigerator circuit (110) while the other end thereof is connected to the gas side closing valve (32).

In the refrigerant circuit (20), further, the air conditioning circuit (100) is connected to the outdoor circuit (40) by means of a second liquid side communication pipe (23) and a second gas side communication pipe (24). The second liquid side communication pipe (23) is connected at one end thereof to the outdoor circuit (40) and at the other end thereof to the liquid side end of the air conditioning circuit (100). The second gas side communication pipe (24) is connected at one end thereof to the outdoor circuit (40) and at the other end thereof to the gas side end of the air conditioning circuit (100).

<Outdoor Unit>

As described above, the outdoor unit (11) includes the outdoor circuit (40). The outdoor circuit (40) includes a variable capacity compressor (41), a fixed capacity compressor (42), an outdoor heat exchanger (43), a receiver (44), and an outdoor expansion valve (45). The outdoor circuit (40) further includes two four-way switching valves (51, 52), two liquid side closing valves (53, 55), and two gas side closing valves (54, 56). In the outdoor circuit (40), the first liquid side communication pipe (21), the first gas side communication pipe (22), the second liquid side communication pipe (23), and the second gas side communication pipe (24) are connected to the first liquid side closing valve (53), the first gas side closing valve (54), the second liquid side closing valve (55), and the second gas side closing valve (56), respectively.

Both the variable capacity compressor (41) and the fixed capacity compressor (42) are hermetic scroll compressors of high-pressure dome type. Electric power is supplied to the variable capacity compressor (41) through an inverter. The variable capacity compressor (41) is variable in capacity by changing the rotation speed of its compressor motor by changing the output frequency of the inverter. The variable capacity compressor (41) serves as a main compressor. In contrast, the fixed capacity compressor (42) is operated by driving its compressor motor always at a given rotation speed, so that the capacity thereof is invariable.

The variable capacity compressor (41) is connected at the suction side thereof to one end of a first suction pipe (61). The other end of the first suction pipe (61) is connected to the first gas side closing valve (54). On the other hand, the fixed capacity compressor is connected at the suction side thereof to one end of a second suction pipe (62). The other end of the second suction pipe (62) is connected to the second four-way switching valve (52). The first suction pipe (61) is connected to one end of a suction connection pipe (63), and the second suction pipe (62) is connected to the other end of the suction connection pipe (63). In the suction connection pipe (63), a check valve (CV-1) is provided for allowing the refrigerant to flow from the one end towards the other end thereof.

To the variable capacity compressor (41) and the fixed capacity compressor (42), a discharge pipe (64) is connected. One end of the discharge pipe (64) is connected to the first four-way switching valve (51). The other end of the discharge pipe (64) branches into a first branch discharge pipe (64a) and a second branch discharge pipe (64b). The first branch discharge pipe (64a) is connected to the discharge side of the variable capacity compressor (41) while the second branch discharge pipe (64b) is connected to the discharge side of the fixed capacity compressor (42). A check valve (CV-3) for allowing the refrigerant to flow from the fixed capacity compressor (42) towards the first four-way switching valve (51) is provided in the second branch discharge pipe (64b). Further, the discharge pipe (64) is connected to one end of a discharge connection pipe (65). The other end of the discharge connection pipe (65) is connected to the second four-way switching valve (52).

The outdoor heat exchanger (43) is a fin and tube heat exchanger of cross fin type and serves as a heat source side heat exchanger. The outdoor heat exchanger (43) performs heat exchange between the refrigerant and outdoor air. One end of the outdoor heat exchanger (43) is connected to the first four-way switching valve (51) via a closing valve (57). The other end of the outdoor heat exchanger (43) is connected to the head of the receiver (44) through a first liquid pipe (81). A check valve (CV-4) for allowing the refrigerant to flow from the outdoor heat exchanger (43) towards the receiver (44) is provided in the first liquid pipe (81).

To the bottom of the receiver (45), one end of a second liquid pipe (82) is connected via a closing valve (58). The other end of the second liquid pipe (82) branches into a first branch pipe (82a) and a second branch pipe (82b). The first branch pipe (82a) of the second liquid pipe (82) is connected to a first liquid side closing valve (53) while the second branch pipe (82b) thereof is connected to a second liquid side closing valve (55). A check valve (CV-5) for allowing the refrigerant to flow from the receiver (44) towards the second liquid side closing valve (55) is provided in the second branch pipe (82b) of the second liquid pipe (82).

A third liquid pipe (83) is connected at one end thereof between the check valve (CV-5) and the second liquid side closing valve (55) in the second branch pipe (82b) of the second liquid pipe (82). The other end of the third liquid pipe (83) is connected to the head of the receiver (44). A check valve (CV-6) for allowing the refrigerant to flow from the one end towards the other end is provided in the third liquid pipe (83).

A fourth liquid pipe (84) is connected at one end thereof downstream of the closing valve (58) in the second liquid pipe (82). The other end of the fourth liquid pipe (84) is connected between the outdoor heat exchanger (43) and the check valve (CV-4) in the first liquid pipe (81). An outdoor expansion valve (45) is provided in the fourth liquid pipe (84).

In the first four-way switching valve (51), the first port, the second port, the third port, and the fourth port are connected to the discharge pipe (64), the second four-way switching valve (52), the outdoor heat exchanger (43), and the second gas side closing valve (56), respectively. The first four-way switching valve (51) is exchangeable between the first state (shown by the solid lines in FIG. 1) that the first port and the third port communicate with each other while the second port and the fourth port communicate with each other and the second state (shown by the broken lines in FIG. 1) that the first port and the fourth port communicate with each other while the second port and the third port communicate with each other.

In the second four-way switching valve (52), the first port, the second port, and the fourth port are connected to the discharge connection pipe (65), the second suction pipe (62), and the second port of the first four-way switching valve (51), respectively. The third port of the second four-way switching valve (52) is closed. This means that the second four-way switching valve substantially serves as a three-way valve. The second four-way switching valve (52) is exchangeable between the first state (shown by the solid lines in FIG. 1) that the first port and the third port communicate with each other while the second port and the fourth port communicate with each other and the second state (shown by the broken lines in FIG. 1) that the first port and the fourth port communicate with each other while the second port and the third port communicate with each other.

The outdoor circuit (40) includes an oil separator (70), an oil return pipe (71), an injection pipe (85), and a communication pipe (87). The outdoor circuit (40) further includes two oil level equalizing pipes (72, 73) and two suction side pipes (66, 67).

The oil separator (70) is provided at the discharge pipe (64). The oil separator (70) is provided for separating the refrigerating machine oil from the discharged gas in the compressors (41, 42). One end of the oil return pipe (71) is connected to the oil separator (70). The other end of the oil return pipe (71) is connected to the first suction pipe (61). A solenoid valve (SV-5) is provided in the oil return pipe (71). When the solenoid valve (SV-5) is opened, the refrigerating machine oil separated in the oil separator (70) is sent back to the suction side of the variable capacity compressor (41).

The first oil level equalizing pipe (72) is connected at one end thereof to the variable capacity compressor (41) and at the other end thereof to the second suction pipe (62). A solenoid valve (SV-1) is provided in the first oil level equalizing pipe (72). The second oil level equalizing pipe (73) is connected at one end thereof to the fixed capacity compressor (42) and at the other end thereof to the first suction pipe (61). A solenoid valve (SV-2) is provided in the second oil level equalizing pipe (73). Appropriate opening/closing of the solenoid valves (SV-1, SV-2) equalizes each amount of the refrigerating machine oil reserved in the compressors (42, 42).

The first suction side pipe (66) is connected at one end thereof to the second suction pipe (62) and at the other end thereof to the first suction pipe (61). In the first suction side pipe (66), a solenoid valve (SV-3) and a check valve (CV-2) are provided in this order from the one end towards the other end. The check valve (CV-2) allows the refrigerant to flow from one end towards the other end of the first suction side pipe (66). On the other hand, the second suction side pipe (67) is connected to the respective sides of the solenoid valve (SV-3) in the first suction side pipe (66). A solenoid valve (SV-4) is provided in the second suction side pipe (67).

The injection pipe (85) is provided for liquid injection. The injection pipe (85) is connected at one end thereof to the fourth liquid pipe (84) via the closing valve (59) and at the other end thereof to the first suction pipe (61). A flow rate adjusting valve (86) variable in opening is provided in the injection pipe (85). One end of the communication pipe (87) is connected between the closing valve (59) and the flow rate adjusting valve (86) in the injection pipe (85). The other end of the communication pipe (87) is connected between the oil separator (70) and the solenoid valve (SV-5) in the oil return pipe (71). A check valve (CV-7) for allowing the refrigerant to flow from the one end towards the other end is provided in the communication pipe (87).

A variety of sensors and pressure switches are provided in the outdoor circuit (40). Specifically, a first suction temperature sensor (91) and a first suction pressure sensor (93) are provided for the first suction pipe (61). A second suction temperature sensor (92) and a second suction pressure sensor (94) are provided for the second suction pipe (62). A discharge temperature sensor (96) and a discharge pressure sensor (97) are provided for the discharge pipe (64). High-pressure switches (95) are provided for the first and second discharge branch pipes (64a, 64b).

The outdoor unit (11) further includes an outdoor air temperature sensor (90) and an outdoor fan (48). The outdoor fan (48) sends outdoor air to the outdoor heat exchanger (43).

<Air Conditioning Unit>

As described above, the air conditioning unit (12) includes the air conditioning circuit (100). The air conditioning circuit (100) includes an air conditioning expansion valve (102) and an air conditioning heat exchanger (101) in this order from the liquid side end towards the gas side end thereof. The air conditioning heat exchanger (101) is a fin and tube heat exchanger of cross fin type. The air conditioning heat exchanger (101) performs heat exchange between the refrigerant and room air. The air conditioning expansion valve (102) is an electronic expansion valve.

The air conditioning unit (12) includes a heat exchanger temperature sensor (103) and a refrigerant temperature sensor (104). The heat exchanger temperature sensor (103) is incorporated at the heat transfer tube of the air conditioning heat exchanger (101). The refrigerant temperature sensor (104) is incorporated in the vicinity of the gas side end of the air conditioning circuit (100). The air conditioning unit (12) also includes a room air temperature sensor (106) and an air conditioning fan (105). The air conditioning fan (105) sends room air in the store to the air conditioning heat exchanger (101).

<Refrigerator Showcase>

As described above, the refrigerator showcase (13) includes the refrigerator circuit (110). The refrigerator circuit (110) includes a refrigeration expansion valve (112) and a refrigeration heat exchanger (111) in this order from the liquid side end towards the gas side end thereof. The refrigeration heat exchanger (111) is a fin and tube heat exchanger of cross fin type and serves as a first heat exchanger. The refrigeration heat exchanger (111) performs heat exchange between the refrigerant and the inside air of the refrigerator showcase (13). The refrigeration expansion valve (112) is an electronic expansion valve.

The refrigerator showcase (13) includes a heat exchanger temperature sensor (113) and a refrigerant temperature sensor (114). The heat exchanger temperature sensor (113) is incorporated at the heat transfer tube of the refrigeration heat exchanger (111). The refrigerant temperature sensor (114) is incorporated at the vicinity of the gas side end of the refrigerator circuit (110). Further, the refrigerator showcase (13) includes a refrigerator temperature sensor (116) and a refrigerator fan (115). The refrigerator fan (115) sends the inside air of the refrigerator showcase (13) to the refrigeration heat exchanger (111).

<Freezer Showcase>

As described above, the freezer showcase (15) includes the freezer circuit (130). The freezer circuit (130) includes a solenoid valve (SV-6), a freezing expansion valve (132), a freezing heat exchanger (131), and a refrigerant temperature sensor (134) in this order from the liquid side end towards the gas side end thereof. The freezing heat exchanger (131) is a fin and tube heat exchanger of cross fin type and serves as a second heat exchanger. The freezing heat exchanger (131) performs heat exchange between the refrigerant and the inside air of the freezer showcase (15). The freezing expansion valve (132) is a thermostatic expansion valve. The freezing expansion valve (132) detects the detection temperature of the refrigerant temperature sensor (134), that is, evaporation temperature of the refrigerant flowing out from the freezing heat exchanger (131) for adjusting the opening of its own.

The freezer circuit (130) includes a first bypass pipe (133). The first bypass pipe (133) is connected at one end thereof between the freezing heat exchanger (131) and the freezing expansion valve (132) and at the other end thereof between the solenoid valve (SV-6) and the liquid side end of the freezer circuit (130). A solenoid valve (SV-7) and a check valve (CV-8) are provided in this order from the one end to the other end of the first bypass passage (133). The check valve (CV-8) allows the refrigerant to flow from the solenoid valve (SV-7) towards the liquid side end of the freezer circuit (130). The first bypass pipe (133) serves as a second bypass passage in which the refrigerant bypassing the freezing expansion valve (132) flows only in second operation, which will be described later.

The freezer showcase (15) includes a freezer temperature sensor (136) and a freezer fan (135). The freezer fan (135) sends the inside air of the freezer showcase (15) to the freezing heat exchanger (131).

<Booster Unit>

As described above, the booster unit (16) includes the booster circuit (140). The booster circuit (140) includes a booster communication pipe (143), a booster compressor (141), and a four-wary switching valve (142).

The booster communication pipe (143) is connected at one end thereof to the first liquid side communication pipe (21) via the liquid side closing valve (31) and at the other end thereof to the liquid side end of the freezer circuit (130). The booster communication pipe (158) sends the liquid refrigerant separated from the first liquid side communication pipe (21) to the freezer circuit (130).

The booster compressor (141) is a hermetic scroll compressor of high pressure dome type. Electric power is supplied to the booster compressor (141) through an inverter. The booster compressor (141) is variable in capacity by changing the rotation speed of its compressor motor by changing the output frequency of the inverter. The booster compressor (141) serves as a sub compressor.

The booster compressor (141) is connected at the suction side thereof to one end of a suction pipe (144) and at the discharge side thereof to one end of a discharge pipe (145). The suction pipe (144) and the discharge pipe (145) are connected at the respective other ends thereof to the four-wary switching valve (142).

In the suction pipe (144), a suction pressure sensor (146) and a suction temperature sensor (147) are provided in the vicinity of the suction side of the booster compressor (141).

A discharge temperature sensor (148), a high pressure switch (149), a discharge pressure sensor (150), an oil separator (151), and a check valve (CV-9) are provided in this order from the discharge side of the booster compressor (141) towards the four-way switching valve (142) in the discharge pipe (145). The check valve (CV-9) allows the refrigerant to flow from the discharge side of the booster compressor (141) towards the four-way switching valve (142).

The oil separator (151) is provided for separating the refrigerating machine oil from the discharge gas in the booster compressor (141). One end of an oil return pipe (152) is connected to the oil separator (151). The other end of the oil return pipe (152) is connected to the suction pipe (144). The oil return pipe (152) includes a capillary tube (153). The refrigerating machine oil separated in the oil separator (151) is sent back to the suction side of the booster compressor (141) through the oil return pipe (152).

In the four-way switching valve (142), the first port and the second port are connected to the discharge pipe (145) and the suction pipe (144), respectively. The third port is connected to the gas side end of the freezer circuit (130) through a pipe. The fourth port is closed. Accordingly, the four-way switching valve (142) is used as a three-way valve for switching the refrigerant flow in three ways. The four-way switching valve (142) is exchangeable between the first state (shown by the solid lines in FIG. 1) that the first port and the fourth port communicate with each other while the second port and the third port communicate with each other and the second state (shown by the broken lines in FIG. 1) that the first port and the third port communicate with each other while the second port and the fourth port communicate with each other.

As described above, the four-way switching valve (142) serves as a three-way switching mechanism (a first three-way switching mechanism) for alternately exchanging the refrigerant circuit (20) between the first operation and the second operation. Specifically, the first three-way switching mechanism (142) is in the first state in the first operation to allow the freezing heat exchanger (131) to communicate with the suction side of the booster compressor (141) while being in the second state in the second operation to allow the freezing heat exchanger (131) to communicate with the discharge side of the booster compressor (141).

Further, the booster circuit (140) includes a main pipe (163) and two branch pipes (161, 162) branching from one end of the main pipe (163) into two ways. The other end of the main pipe (163) is connected to the first gas side communication pipe (22) via the gas side closing valve (32).

The branch pipes (161, 162) are a first branch pipe (161) connected to the suction pipe (144) and a second branch pipe (162) connected to the discharge pipe (145). In the first branch pipe (161), a solenoid valve (an on-off valve) (SV-8) and a check valve (CV-10) are provided in this order from the end connected to the main pipe (163). The check valve (CV-10) allows the refrigerant to flow from the main pipe (163) towards the suction pipe (144). A solenoid valve (on-off valve) (SV-9) is provided in the second branch pipe (162).

The solenoid valves (SV-8, SV-9) are freely opened and closed keeping up with the relation that one of them is opened when the other is closed. Specifically, the solenoid valves (SV-8, SV-9) are exchangeable between the first state that the solenoid valve (SV-8) is closed while the solenoid valve (SV-9) is opened and the second state that the solenoid valve (SV-8) is opened while the solenoid valve (SV-9) is closed.

The main pipe (163), the branch pipes (161, 162), and the solenoid valves (SV-8, SV-9) as described above serve as a three-way switching mechanism (a second three-way switching mechanism) (160) for alternately exchanging the refrigerant circuit (20) between the first operation and the second operation. Specifically, the second three-way switching mechanism (160) is in the first state in the first operation to allow the discharge side of the booster compressor (141) to communicate with the first gas side communication pipe (22) (the suction side of the main compressor (41)) while being in the second state in the second operation to allow the suction side of the booster compressor (141) to communicate with the first gas side communication pipe (22) (the outlet side of the refrigeration heat exchanger (111)).

The booster circuit includes (140) an oil discharge pipe (154), an injection pipe (155), and a second bypass pipe (156).

The oil discharge pipe (154) is connected at one end thereof to the booster compressor (141) and at the other end thereof to the main pipe (163). A solenoid valve (SV-10) is provided in the oil discharge pipe (154). When the solenoid valve (SV-10) is opened when the refrigerating machine oil is reserved excessively in the booster compressor (141), the oil discharge pipe (154) sends the excessive refrigerating machine oil to the outdoor circuit (40) so that the refrigerating machine oil is sucked into the variable capacity compressor (41) and the fixed capacity compressor (42).

The injection pipe (155) is provided for liquid injection. The injection pipe (155) is connected at one end thereof to the booster communication pipe (143) and at the other end thereof to the suction pipe (144) through the oil return pipe (152). A flow rate adjusting valve (157) variable in opening is provided in the injection pipe (155).

The second bypass pipe (156) is connected at one end thereof to the part connecting the main pipe (163) and the first branch pipe (161) and at the other end thereof to the part connecting the suction pipe (144) and the first branch pipe (161). In the second bypass pipe (156), a check valve (CV-11) is provided for allowing the refrigerant to flow from the one end towards the other end thereof. The second bypass pipe (156) serves as a second bypass passage in which the refrigerant bypassing the booster compressor (141) flows only during stop of the booster compressor (141).

<Constitution of Controller>

The refrigerating apparatus (10) of the present embodiment includes a controller (200). The controller (200) performs control operation for each of the four-way switching valves, the solenoid valves, and the like according to the driving condition. The controller (200) includes a switching control section (202). The switching control section (202) serves as control means for performing control operation to the booster compressor (141) at exchange of the refrigerant circuit (20) from the second operation to the first operation.

Driving Operation

Main operations of driving operation that the refrigerating apparatus (10) performs will be described with reference to the drawings.

<Cooling Operation>

Cooling operation is operation for cooling the inside air of the refrigerator showcase (13) and of the freezer showcase (15) and for cooling room air by the air conditioning unit (12) to cool the inside of the store.

As shown in FIG. 2, in the outdoor circuit (40), the first four-way switching valve (51) and the second four-way switching valve (52) are set to the first state. The four-way switching valve (142) as the first three-way switching mechanism is set to the first state in the booster circuit (140). The second three-way switching mechanism (160) is set to the first state where the solenoid valve (SV-8) is closed while the solenoid valve (SV-9) is opened. This means that the booster circuit (140) performs the first operation. In the freezer circuit (130), the solenoid valve (SV-6) is opened while the solenoid valve (SV-7) in the first bypass pipe (133) is closed. Further, the outdoor expansion valve (45) is closed fully, and each opening of the air conditioning expansion valve (102), the refrigeration expansion valve (112), and the freezing expansion valve (132) is adjusted appropriately. In this condition, the variable capacity compressor (41), the fixed capacity compressor (42), and the booster compressor (141) are driven.

The refrigerant discharged from the variable capacity compressor (41) and the fixed capacity compressor (42) is sent from the discharge pipe (64) to the outdoor heat exchanger (43) via the first four-way switching valve (51). In the outdoor heat exchanger (43), the refrigerant radiates heat to outdoor air to be condensed. The refrigerant condensed in the outdoor heat exchanger (43) passes through the receiver (44), flows into the second liquid pipe (82), and then, is distributed into the respective branch pipes (82a, 82b) of the second liquid pipe (82).

The refrigerant flowing in the first branch pipe (82a) of the second liquid pipe (82) passes through the first liquid side communication pipe (21) and is distributed into the refrigerator circuit (110) and the booster circuit (140).

The refrigerant flowing in the refrigerator circuit (110) is pressure-reduced when passing through the refrigeration expansion valve (112), and then, is introduced into the refrigeration heat exchanger (111). In the refrigeration heat exchanger (111), the refrigerant absorbs heat from the inside air to be evaporated. For the evaporation, the refrigeration heat exchanger (111) is so set that the evaporation temperature of the refrigerant is set to be −520 C., for example. The refrigerant evaporated in the refrigeration heat exchanger (111) flows into the first gas side communication pipe (22). The inside air cooled in the refrigeration heat exchanger (111) is supplied to the inside of the refrigerator showcase (13) so that the inside temperature is kept at 5° C., for example.

The refrigerant flowing in the booster circuit (140) is introduced into the freezer circuit (130) through the booster communication pipe (143). This refrigerant is pressure-reduced when passing through the freezing expansion valve (132), and then, is introduced into the freezing heat exchanger (131). In the freezing heat exchanger (131), the refrigerant absorbs heat from the inside air to be evaporated. For the evaporation, the freezing heat exchanger (131) is so set that the evaporation temperature of the refrigerant is set to be −30° C., for example. The inside air cooled in the freezing heat exchanger (131) is supplied to the inside of the freezer showcase (15) so that the inside temperature is kept at −20° C., for example.

The refrigerant evaporated in the freezing heat exchanger (131) flows into the booster circuit (140), passes through the four-way switching valve (142), and then, is sucked into the booster compressor (141). The refrigerant compressed in the booster compressor (141) passes through the discharge pipe (145) and the second branch pipe (162), and then, flows into the first gas side communication pipe (22).

In the first gas side communication pipe (22), the refrigerant sent from the refrigerator circuit (110) and the refrigerant sent from the booster circuit (140) are combined together. Then, the combined refrigerant flows into the first suction pipe (61) from the first gas side communication pipe (22) to be sucked into the variable capacity compressor (41). The variable capacity compressor (41) compresses the sucked refrigerant and discharges it to the first branch discharge pipe (64a) of the discharge pipe (64).

On the other hand, the refrigerant flowing in the second branch pipe (82b) of the second liquid pipe (82) is supplied to the air conditioning circuit (100) through the second liquid side communication pipe (23). The refrigerant flowing in the air conditioning circuit (100) is pressure-reduced when passing through the air conditioning expansion valve (102), and then, is introduced into the air conditioning heat exchanger (101). In the air conditioning heat exchanger (101), the refrigerant absorbs heat from room air to be evaporated. The room air cooled in the air conditioning heat exchanger (101) is supplied to the inside of the store by the air conditioning unit (12). The refrigerant evaporated in the air conditioning heat exchanger (101) passes through the second gas side communication pipe (24), flows into the outdoor circuit (40), passes through the first four-way switching valve (51) and the second four-way switching valve (52) in this order, and then, passes through the second suction pipe (62) to be sucked into the fixed capacity compressor (42). The fixed capacity compressor (42) compresses the sucked refrigerant and discharges it to the second branch discharge pipe (64b) of the discharge pipe (64).

<First Heating Operation>

First heating operation is operation for cooling the inside air of the refrigerator showcase (13) and of the freezer showcase (15) and for heating room air by the air conditioning unit (12) to heat the inside of the store.

As shown in FIG. 3, in the outdoor circuit (40), the first four-way switching valve (51) and the second four-way switching valve (52) are set to the second state and the first state, respectively. In the booster circuit (140), the four-ways witching valve (142) as the first three-way switching mechanism is set to the first state. The second three-way switching mechanism (160) is set to the first state where the solenoid valve (SV-8) is closed while the solenoid valve (SV-9) is opened. This means that the booster circuit (140) performs the first operation. In the freezer circuit (130), the solenoid valve (SV-6) is opened while the solenoid valve (SV-7) of the first bypass pipe (133) is closed. Further, the outdoor expansion valve (45) is closed fully, and each opening of the air conditioning expansion valve (102), the refrigeration expansion valve (112), and the freezing expansion valve (132) is adjusted appropriately. In this condition, the variable capacity compressor (41) and the booster compressor (141) are driven while the fixed capacity compressor (42) is stopped. Further, the outdoor heat exchanger (43) is stopped with no refrigerant sent thereto.

The refrigerant discharged from the variable capacity compressor (41) passes through the second gas side communication pipe (24), is introduced into the air conditioning heat exchanger (101) of the air conditioning circuit (100), and then, radiates heat to outdoor air to be condensed. In the air conditioning unit (12), the room air heated in the air conditioning heat exchanger (101) is supplied to the inside of the store. The refrigerant condensed in the air conditioning heat exchanger (101) is sent back to the outdoor circuit (40) through the second liquid side communication pipe (23), passes through the receiver (44), and then, flows into the second liquid pipe (82).

The refrigerant flowing in the second liquid pipe (82) is distributed into the refrigerator circuit (110) and the booster circuit (140) (the freezing circuit (30)) through the first liquid side communication pipe (21). In the refrigerator showcase (13) and the freezer showcase (15), the inside air thereof is cooled, similarly to the aforementioned cooling operation. The refrigerant evaporated in the refrigeration heat exchanger (111) passes through the first gas side communication pipe (22), and then, flows into the first suction pipe (61). On the other hand, the refrigerant evaporated in the freezing heat exchanger (131) is compressed in the booster compressor (141), passes through the first gas side communication pipe (22), and then, flows into the first suction pipe (61). The refrigerant flowing in the first suction pipe (61) is sucked into the variable capacity compressor (41) to be compressed.

As described above, in the first heating operation, the refrigerant absorbs heat in the refrigeration heat exchanger (111) and the freezing heat exchanger (131) while the refrigerant radiates heat in the air conditioning heat exchanger (101). Then, the inside of the store is heated by utilizing the heat that the refrigerant absorbs from the inside air of the refrigeration heat exchanger (111) and the freezing heat exchanger (131).

It is noted that in the first heating operation, the fixed capacity compressor (42) may be operated. Whether or not the fixed capacity compressor (42) is to be operated is determined depending on cooling loads of the refrigerator showcase (13) and the freezer showcase (15). In this case, part of the refrigerant flowing in the first suction pipe (61) passes through the suction connection pipe (63) and the second suction pipe (62) to be sucked into the fixed capacity compressor (42).

<Second Heating Operation>

Second heating operation is operation for heating the inside of the store, similarly to the first heating operation. The second heating operation is performed in the case where the heating power in the first heating operation is excessive.

As shown in FIG. 4, in the outdoor circuit (40), the first four-way switching valve (51) and the second four-way switching valve (52) are set to the second state. In the booster circuit (140), the four-ways witching valve (142) as the first three-way switching mechanism is set to the first state. The second three-way switching mechanism (160) is set to the first state where the solenoid valve (SV-8) is closed while the solenoid valve (SV-9) is opened. This means that the booster circuit (140) performs the first operation. In the freezer circuit (130), the solenoid valve (SV-6) is opened while the solenoid valve (SV-7) of the first bypass pipe (133) is closed. Further, the outdoor expansion valve (45) is closed fully, and each opening of the air conditioning expansion valve (102), the refrigeration expansion valve (112), and the freezing expansion valve (132) is adjusted appropriately. In this condition, the variable capacity compressor (41) and the booster compressor (141) are driven while the fixed capacity compressor (42) is stopped.

Part of the refrigerant discharged from the variable capacity compressor (41) passes through the second gas side communication pipe (24), and then, is introduced into the air conditioning heat exchanger (101) of the air conditioning circuit (100) while the other part of the refrigerant passes through the discharge connection pipe (65), and then, is introduced into the outdoor heat exchanger (43). The refrigerant introduced in the air conditioning heat exchanger (101) radiates heat to room air to be condensed, passes through the second liquid side communication pipe (23) and the third liquid pipe (83) of the outdoor circuit (40), and then, flows into the receiver (44). The refrigerant introduced in the outdoor heat exchanger (43) radiates heat to outdoor air to be condensed, passes through the first liquid pipe (81), and then, flows into the receiver (44).

The refrigerant flowing in the second liquid pipe (82) from the receiver (44) is distributed into the refrigerator circuit (110) and the booster circuit (140) (the freezing circuit (30)) through the first liquid side communication pipe (21), similar to the first heating operation. In the refrigerator showcase (13) and the freezer showcase (15), the inside air thereof is cooled. The refrigerant evaporated in the refrigeration heat exchanger (111) passes through the first gas side communication pipe (22), and then, flows into the first suction pipe (61). On the other hand, the refrigerant evaporated in the freezing heat exchanger (131) is compressed in the booster compressor (141), passes through the first gas side communication pipe (22), and then, flows into the first suction pipe (61). The refrigerant flowing in the first suction pipe (61) is sucked into the variable capacity compressor (41) to be compressed.

As described above, in the second heating operation, the refrigerant absorbs heat in the refrigeration heat exchanger (111) and the freezing heat exchanger (131) while the refrigerant radiates heat in the air conditioning heat exchanger (101) and the outdoor heat exchanger (43). Then, part of the heat that the refrigerant absorbs from the inside air in the refrigeration heat exchanger (111) and the freezing heat exchanger (131) is utilized for heating the inside of the store while the other part thereof is released outdoors.

It is noted that in the second heating operation, the fixed capacity compressor (42) may be operated. Whether or not the fixed capacity compressor (42) is to be operated is determined depending on cooling loads of the refrigerator showcase (13) and the freezer showcase (15). In this case, part of the refrigerant flowing in the first suction pipe (61) passes through the suction connection pipe (63) and the second suction pipe (62) to be sucked into the fixed capacity compressor (42).

<Third Heating Operation>

Third heating operation is operation for heating the inside of the store, similarly to the first heating operation. The third heating operation is performed in the case where the heating power in the first heating operation only is insufficient.

As shown in FIG. 5, in the outdoor circuit (40), the first four-way switching valve (51) and the second four-way switching valve (52) are set to the second state and the first state, respectively. In the booster circuit (140), the four-way switching valve (142) as the first three-way switching mechanism is set to the first state. The second three-way switching mechanism (160) is set to the first state where the solenoid valve (SV-8) is closed while the solenoid valve (SV-9) is opened. This means that the booster circuit (140) performs the first operation. In the freezer circuit (130), the solenoid valve (SV-6) is opened while the solenoid valve (SV-7) of the first bypass pipe (133) is closed. Further, each opening of the outdoor expansion valve (45), the air conditioning expansion valve (102), the refrigeration expansion valve (112), and the freezing expansion valve (132) is adjusted appropriately. In this condition, the variable capacity compressor (41), the fixed capacity compressor (42), and the booster compressor (141) are driven.

The refrigerant discharged from the variable capacity compressor (41) and the fixed capacity compressor (42) passes through the second gas side communication pipe (24), is introduced into the air conditioning heat exchanger (101) of the air conditioning circuit (100), and then, radiates heat to outdoor air to be condensed. In the air conditioning unit (12), the room air heated in the air conditioning heat exchanger (101) is supplied to the inside of the store. The refrigerant condensed in the air conditioning heat exchanger (101) passes through the second liquid side communication pipe (23) and the third liquid pipe (83), and then, flows into the receiver (44). Part of the refrigerant flowing from the receiver (44) into the second liquid pipe (82) flows into the first liquid side communication pipe (21) while the other part thereof flows into the fourth liquid pipe (84).

The refrigerant flowing in the first liquid side communication pipe (21) is distributed into the refrigerator circuit (110) and the booster circuit (140) (the freezing circuit (30)). In the refrigerator showcase (13) and the freezer showcase (15), the inside air thereof is cooled, similar to the first heating operation. The refrigerant evaporated in the refrigeration heat exchanger (111) passes through the first gas side communication pipe (22), and then, flows into the first suction pipe (61). On the other hand, the refrigerant evaporated in the freezing heat exchanger (131) is compressed in the booster compressor (141), passes through the first gas side communication pipe (22), and then, flows into the first suction pipe (61). The refrigerant flowing in the first suction pipe (61) is sucked into the variable capacity compressor (41) to be compressed.

On the other hand, the refrigerant flowing in the fourth liquid pipe (84) is pressure-reduced when passing through the outdoor expansion valve (45), is introduced into the outdoor heat exchanger (43), and then, absorbs heat from outdoor air to be evaporated. The refrigerant evaporated in the outdoor heat exchanger (43) flows into the second suction pipe (62), and then, is sucked into the fixed capacity compressor (42) to be compressed.

As described above, in the second heating operation, the refrigerant absorbs heat in the refrigeration heat exchanger (111), the freezing heat exchanger (131), and the outdoor heat exchanger (43) while the refrigerant radiates heat in the air conditioning heat exchanger (101). Then, the heat that the refrigerant absorbs from the inside air in the refrigeration heat exchanger (111) and the freezing heat exchanger (131) and the heat that the refrigerant absorbs from outdoor air in the outdoor heat exchanger (43) are utilized for heating the inside of the store.

<Defrosting Operation>

The above refrigerating apparatus (10) performs defrosting operation. The defrosting operation is performed for melting frost adhering to the freezing heat exchanger (131) of the freezer showcase (15).

In cooling the inside air in the freezing heat exchanger (131), moisture in the inside air becomes frost and adheres to the freezing heat exchanger (131). When the amount of frost adhering to the freezing heat exchanger (131) becomes larger the flow rate of the inside air passing through the freezing heat exchanger (131) decreases, so that the inside air is cooled insufficiently. In this view, the refrigerating apparatus (10) performs the defrosting operation for removing the frost adhering to the freezing heat exchanger (131).

Transition to the defrosting operation from the cooling operation or any of the heating operations is performed according to defrosting start judging means (not shown) provided in the controller (200). The defrosting start judging means in the present embodiment switches the refrigerant circuit (20) from the first operation to the second operation after the first operation, that is, cooling of the inside by the freezing heat exchanger (131) is performed for a predetermined time period (six hours, for example) so as to allow the defrosting operation to start.

It is noted that as another embodiment, the defrosting start judging means may detect indirectly the state in which the amount of frost adhering to the freezing heat exchanger (131) is equal to or greater than a predetermined amount to allow the defrosting operation to start. Specifically, the defrosting start judging means switches the refrigerant circuit (20) from the cooling operation or any of the heating operation to the defrosting operation when the pressure of the refrigerant flowing in the freezing heat exchanger (131) is equal to or smaller than a predetermined pressure, when temperature difference between the suction temperature and the discharge temperature in the freezer showcase (15), that is, temperature difference between air temperatures before and after the refrigerant passes through the freezing heat exchanger (131) is equal to or smaller than a predetermined temperature, when a weight of the freezer showcase (15) or the freezing heat exchanger (131) measured by a scale is equal to or greater than a predetermined weight, when the number of rotation of the motor of the freezer fan (135) decreases or the current value of the motor varies by a predetermined value, which are due to increase in flowing air resistance of the freezer fan (135) in association with frosting over the freezing heat exchanger (131), when the inside temperature of the freezer showcase (13) is equal to or higher than a predetermined temperature, or the like.

During the defrosting operation, defrosting of the freezing heat exchanger (131) and the cooling of the inside air of the refrigerator showcase (13) are performed in parallel. Herein, difference of the defrosting operation from the cooling operation and each heating operation in the refrigerating apparatus (10) will be described with reference to FIG. 6. Wherein, FIG. 6 shows a refrigerant flow when the defrosting operation is performed in the cooling operation.

In the booster circuit (140), the four-wary switching valve (142) as the first three-way switching mechanism is set to the second state, and the second three-way switching mechanism (160) is set to the second state where the solenoid valve (SV-8) is opened while the solenoid valve (SV-9) is closed. This means that the booster circuit (140) performs the second operation. Further, in the freezer circuit (130), the solenoid valve (SV-6) is closed and the solenoid valve (SV-7) of the first bypass pipe (133) is opened.

Part of the refrigerant flowing in the first gas side communication pipe (22), that is, part of the refrigerant evaporated in the refrigeration heat exchanger (111) is taken into the booster circuit (140). The refrigerant taken in the booster circuit (140) flows into the suction pipe (144), and then, is sucked into the booster compressor (141) to be compressed. The refrigerant discharged from the booster compressor (141) to the discharge pipe (145) is supplied to the freezing heat exchanger (131) of the freezer circuit (130). In the freezing heat exchanger (131), the supplied refrigerant radiates heat to be condensed. Frost adhering to the freezing heat exchanger (131) is heated and melted by the heat of condensation of the refrigerant.

The refrigerant condensed in the freezing heat exchanger (131) passes through the first bypass pipe (133). The refrigerant bypassing the freezing expansion valve (132) in this way flows into the first liquid side communication pipe (21) through the booster communication pipe (143). The refrigerant flowing in the first liquid side communication pipe (21) is supplied to the refrigerator circuit (110) together with the refrigerant sent from the outdoor circuit (40), passes through the refrigeration expansion valve (112), and then, is sent back to the refrigeration heat exchanger (111).

As described above, in the defrosting operation of the refrigerating apparatus (10), the refrigerant that absorbs heat from the inside air in the refrigeration heat exchanger (111) is sucked into the booster compressor (141), and the refrigerant compressed in the booster compressor (141) is sent to the freezing heat exchanger (131). Accordingly, in the defrosting operation, not only the heat provided to the refrigerant in the booster compressor (141) but also the heat that the refrigerant absorbs from the inside air of the refrigerator showcase (13) are utilized for melting frost adhering to the freezing heat exchanger (131).

Further, in the defrosting operation, the refrigerant condensed in the freezing heat exchanger (131) is sent back to the refrigeration heat exchanger (111) through the first bypass pipe (133). This means that in the defrosting operation, the refrigerant of which enthalpy is lowered by heat radiation in the freezing heat exchanger (131) is supplied to the refrigeration heat exchanger (111), so that the refrigerant utilized for defrosting the freezing heat exchanger (131) is utilized again for cooling the inside air of the refrigerator showcase (13).

The transition to the defrosting operation from the cooling operation or any of the heating operations is performed according to defrosting end judging means (not shown) provided in the controller (200). The defrosting end judging means in the present embodiment terminates the defrosting operation by switching the refrigerant circuit (20) from the second operation to the first operation when the second operation, that is, the defrosting of the freezing heat exchanger (131) is performed for a predetermined time period (one hour, for example).

It is noted that as another embodiment, the defrosting end judging means may detect indirectly the state in which the amount of frost adhering to the freezing heat exchanger (131) is equal to or smaller than a predetermined amount to allow the defrosting operation to terminate. Specifically, the defrosting end judging means terminates the defrosting operation and allows the cooling of the inside of the freezing showcase (13) to start again when the pressure of the refrigerant discharged from the booster compressor (141) is equal to or greater than a predetermined pressure, when the temperature of the refrigerant flowing in the freezing heat exchanger (131) is equal to or higher than a predetermined temperature (5° C., for example), when the inside temperature of the freezing showcase (13) is equal to or higher than a predetermined temperature (0° C., for example), or the like.

As described above, during the defrosting operation, the refrigerant supplied from. the booster compressor (141) is condensed in the freezing heat exchanger (131), and the thus condensed refrigerant is sent to the first liquid side communication pipe (21). However, only part of the refrigerant condensed in the freezing heat exchanger (131) is sent to the refrigeration heat exchanger (111) and the other part thereof remains in the freezing heat exchanger (131). For this reason, if the first and second three-way switching mechanisms (146, 160) of the booster circuit (140) would be swiftly returned back from the second state to the first state at termination of the defrosting operation, the booster compressor (141) would suck the liquid refrigerant remaining in the freezing heat exchanger (131) to cause the booster circuit (141) to be broken.

In this view, in the refrigerating apparatus (10), the switching control section (202) of the controller (200) performs given control operation in termination of the defrosting operation to prevent the booster compressor (141) from damage. This control operation by the switching control section (202) will be described with reference to FIG. 7. Wherein, FIG. 7 shows a refrigerant flow in termination of the defrosting operation in the cooling operation.

When a condition for terminating the defrosting operation is satisfied, the switching control section (202) switches the four-ways witching valve (142) from the second state (the state shown in FIG. 6) to the first state (the state shown in FIG. 7), and stops the booster compressor (141) immediately thereafter. Then, the booster compressor (141) is kept stopping for a predetermined time period (approximately 10 minutes, for example).

In this condition, the liquid refrigerant remaining in the freezing heat exchanger (131) in the defrosting operation is sucked out to the first gas side communication pipe (22). In detail, the liquid refrigerant in the freezing heat exchanger (131) passes through the four-wary switching valve (142) of the booster circuit (140), flows into the second bypass pipe (156), and then, flows into the first gas side communication pipe (22). The liquid refrigerant flowing in the first gas side communication pipe (22) from the booster circuit (140) is mixed with the gas refrigerant flowing from the refrigeration heat exchanger (111) towards the variable capacity compressor (41) to be evaporated, and then, is sucked into the variable capacity compressor (41).

As described above, the liquid refrigerant from the freezing heat exchanger (131) is discharged during the time when the switching control section (202) keeps the booster compressor (141) stopping. The time period (the predetermined time period) for which the switching control section (202) keeps the booster compressor (141) stopping is set taking account of time required for completely discharging the liquid refrigerant from the freezing heat exchanger (131). After the predetermined time period elapses, the switching control section (202) allows the booster compressor (141) to start operating. Accordingly, the situation that the booster compressor (141) sucks the liquid refrigerant remaining in the freezing heat exchanger (131) in the defrosting operation can be avoided, preventing the booster compressor (41) form damage.

Effects of Embodiment

The following effects are exhibited in the above embodiment.

In the refrigerating apparatus (10) of the present embodiment, not only the heat provided to the refrigerant in the booster compressor (141) but also the heat that the refrigerant absorbs from the inside air in the refrigeration heat exchanger (111) can be utilized as the heat for melting frost of the freezing heat exchanger (131) in the defrosting operation. Thus, in the present embodiment, a larger amount of heat that can be utilized for defrosting the freezing heat exchanger (131) can be secured than in the conventional case, resulting in remarkable reduction in time required for defrosting the freezing heat exchanger(131).

Further, in the refrigerating apparatus (10) of the present embodiment, the refrigerant condensed in the freezing heat exchanger (131) in the defrosting operation is sent back to the refrigeration heat exchanger (111) so as to be used again for cooing the inside of the refrigerator. Accordingly, the refrigerant of which enthalpy is lowered by heat radiation in the freezing heat exchanger (131) is sent to the refrigeration heat exchanger (111) so as to be utilized for cooling the inside of the refrigerator. Thus, the refrigeration heat exchanger (111) can obtain cooling power also by driving the booster compressor (141) in the defrosting operation, resulting in reduction in power consumption in the variable capacity compressor (41) by the thus obtained cooling power. Hence, according to the present embodiment, power consumption can be reduced in the variable capacity compressor (41) and the booster compressor (141), and in turn, in the refrigerating apparatus (10), resulting in reduction in running cost thereof.

Furthermore, in the refrigerating apparatus (10) of the present embodiment, the refrigerant supplied to the freezing heat exchanger (131) in the defrosting operation is sent back to the refrigeration heat exchanger (111) through the first bypass pipe (133). This attains reliable sending of the refrigerant in the freezing heat exchanger (131) to the first heat exchanger (111) even in the case where the thermostatic expansion valve (132) is closed fully or closed to some degree because of an influence of the temperature of the refrigerant flowing in the freezing heat exchanger (131), for example. Hence, according to the present embodiment, the refrigerant condensed in the second heat exchanger (131) in the defrosting operation can be sent out to the first heat exchanger (111) without receiving any influence of opening of the thermostatic expansion valve (132).

Moreover, in the refrigerating apparatus (10) of the present embodiment, the switching control section (202) stops the booster compressor (141) temporally in termination of the defrosting operation for discharging the liquid refrigerant from the freezing heat exchanger (131) through the second bypass pipe (156) during the stop of the booster compressor (141). Accordingly, the situation that the liquid refrigerant remaining in the freezing heat exchanger (131) in the defrosting operation is sucked into the booster compressor (141) can be avoided reliably, resulting in reliable prevention of the booster compressor (141) from damage to enhance the reliability of the refrigerating apparatus (10).

<Modified Example of Embodiment>

Next, a modified example of the above embodiment will be described. The present modified example is different from the above embodiment in construction of the freezer circuit (130). Only the difference from the above embodiment will be described.

As shown in FIG. 8, in the present modified example, the freezer circuit (130) excludes the first bypass pipe (133) of the above embodiment and an electronic expansion valve (138) variable in opening is provided rather than the thermostatic expansion valve (132) of the above embodiment. Further, in the freezer circuit (130), a heat exchanger temperature sensor (139) and a refrigerant temperature sensor (134) are provided in addition. The heat exchanger temperature sensor (139) is incorporated at the heat transfer tube of the freezing heat exchanger (131). The refrigerant temperature sensor (134) is incorporated in the vicinity of the gas side end of the freezer circuit (130).

Further, in the present modified example, an opening control section (201) as control means is provided in the controller (200). The opening control section (201) keeps the electronic expansion valve (138) being opened fully in the second operation.

In the present modified example, when the second operation is performed in the defrosting operation, the opening control section (201) keeps the electronic expansion valve (138) being opened fully. Accordingly, when the refrigerant compressed in the booster compressor (141) in the defrosting operation is supplied to the freezing heat exchanger (131), this refrigerant is sent out to the refrigeration heat exchanger (111) via the electronic expansion valve (138) which is opened fully. Hence, according to the refrigerating apparatus (10) of the present modified example, the refrigerant condensed in the second heat exchanger (131) in the defrosting operation can be sent to the first heat exchanger (111) reliably.

<Other Embodiments>

The present invention may have any of the following variations from the above embodiment.

In the above embodiment, the four-way switching valve, which substantially serves as a three-way valve, is used as the first three-way switching mechanism (142) while the main pipe (163), the first and second branch pipes (161, 162), and the solenoid valves (SV-8, SV-9) are used as the second three-way switching mechanism (160) in the booster circuit (140). However, each of the first and second three-way switching mechanisms (142, 160) may be a three-way valve or may be composed of a main pipe, two branch pipes, and two solenoid valves, for example.

Moreover, the three-way switching mechanism (142) in the above embodiment serves as a three-way valve by closing one of the four ports of the four-way switching valve. However, it is needless to say that the three-way switching mechanism (142) may be a three-way valve having only three ports.

In addition, the refrigerant circuit (20) includes the air conditioning unit (12) in the above embodiment. However, there may be provided, rather than the air conditioning unit (12), a second refrigerator circuit having a second refrigeration heat exchanger so as to function as a second refrigerator showcase. Alternatively, such a second refrigerator showcase may be added to the refrigerating apparatus of the above embodiment.

### INDUSTRIAL APPLICABILITY

As described above, the present invention is useful for refrigerating apparatuses including a plurality of heat exchangers for cooling the inside of refrigerator and the like.

1. A refrigerating apparatus, comprising a refrigerant circuit in which a first cooling circuit having a first heat exchanger for cooling inside and a second cooling circuit having a second heat exchanger for cooling inside and a sub compressor are connected in parallel to a heat source side circuit having a main compressor,
wherein the refrigerant circuit includes three-way switching mechanisms for switching between first operation for sending, after refrigerant from the second heat exchanger is compressed in the sub compressor, the refrigerant to a suction side of the main compressor and second operation for circulating, after refrigerant from the first heat exchanger is compressed in the sub compressor, the refrigerant to the first heat exchanger through the second heat exchanger, and
the refrigerant circuit performs the second operation during defrosting operation for defrosting the second heat exchanger.

2. The refrigerating apparatus of claim 1,
wherein the three-way switching mechanisms are a first three-way switching mechanism for allowing the second heat exchanger to communicate with a suction side of the sub compressor in the first operation and allowing the second heat exchanger to communicate with a discharge side of the sub compressor in the second operation and a second three-way switching mechanism for allowing the suction side of the main compressor to communicate with the discharge side of the sub compressor in the first operation and allowing the suction side of the main compressor to communicate with the suction side of the sub compressor in the second operation.

3. The refrigerating apparatus of claim 2,
wherein the three-way switching mechanisms are three-way valves.

4. The refrigerating apparatus of claim 2,
wherein each of the three-way switching mechanisms is composed of a main pipe, two branch pipes branching in two ways from the main pipe, and a pair of on-off valves which are provided in the branch pipes and one of which is closed when the other is opened.

5. The refrigerating apparatus of any one of claims 1 to claim 4,
wherein the second cooling circuit includes: a thermostatic expansion valve which detects temperature of the refrigerant flowing out from the second heat exchanger for adjusting opening of its own; and a first bypass passage in which refrigerant bypassing the thermostatic expansion valve flows in only the second operation.

6. The refrigerating apparatus of any one of claims 1 to claim 4,
wherein the second cooling circuit includes an expansion valve variable in opening, and
the refrigerating apparatus further comprising:
control means for keeping the expansion valve being opened fully in the second operation.

7. The refrigerating apparatus of any one of claims 1 to claim 4,
wherein the refrigerant circuit includes a second bypass passage in which refrigerant bypassing the sub compressor flows during stop of the sub compressor, and
the refrigerating apparatus further comprising:
control means for stopping, in transition from the second operation to the first operation in termination of the defrosting operation, the sub compressor for a predetermined time period and allowing the sub compressor to start operating thereafter.

8. The refrigerating apparatus of any one of claims 1 to claim 4, further comprising:
defrosting start judging means for allowing the defrosting operation to start by switching the refrigerant circuit from the first operation to the second operation, the defrosting start judging means allowing the defrosting operation to start on the basis of elapsed time after the first operation starts, an amount of frost of the second heat exchanger, or inside temperature of equipment in which the second heat exchanger is provided.

9. The refrigerating apparatus of any one of claims 1 to claim 4, further comprising:
defrosting end judging means for terminating the defrosting operation by switching the refrigerant circuit from the second operation to the first operation, the defrosting start judging means terminating the defrosting operation on the basis of elapsed time after the second operation starts, discharge pressure of the sub compressor, temperature of the refrigerant flowing in the second heat exchanger, or inside temperature of equipment in which the second heat exchanger is provided.
